(19) United States
(12) Patent Application Publication
(10) Pub. No.: US 2008/0089193 A1
(43) Pub. Date: Apr. 17, 2008

(54) APPARATUS AND METHOD FOR CONTROLLING FOCUS JUMP BETWEEN RECORDING LAYERS IN HIGH-DENSITY MULTI-LAYER DISK

(75) Inventors: Sung-hyun Kim, Yongin-si (KR); Young-jae Park, Yongin-si (KR); Tatsuhiro Otsuka, Suwon-si (KR); Kab-hyun Jeong, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/748,114

(22) Filed: May 14, 2007

(30) Foreign Application Priority Data
Oct. 11, 2006 (KR) 2006-98867

(51) Int. Cl. G11B 7/00; G11B 7/085

(52) U.S. Cl. 369/44.27; 250/201.5; 369/44.25

(57) ABSTRACT

An apparatus and method for controlling a focus jump between recoding layers in a high-density multi-layer disk. The apparatus includes: an optical pickup including an objective lens focusing light on the disk, an aberration correcting unit, and a photodetector detecting light reflected from the disk; a signal processing unit generating a focus error signal from a signal output by the photodetector; a focus hold unit holding a focus servo of the optical pickup; a focus servo control unit controlling the focus servo of the optical pickup using the focus error signal; and a driving unit driving the optical pickup using a signal output by the focus servo control unit.

### CROSS-REFERENCE TO RELATED PATENT APPLICATION

This application claims the benefit of Korean Patent Application No. 2006-98867, filed Oct. 11, 2006 in the Korean Intellectual Property Office, the disclosure of which is incorporated herein by reference.

### BACKGROUND OF THE INVENTION

1. Field of the Invention

Aspects of the present invention relate to an apparatus and method of controlling a focus jump between recording layers in a high-density multi-layer disk using an objective lens having a high numerical aperture and a light source emitting light that has a short wavelength.

2. Description of the Related Art

In general, optical disks are widely used as information recording media for optical pickups that record and/or reproduce information without contacting the optical disk. Optical disks are classified into compact disks (CDs) and digital versatile disks (DVDs) according to information recording capacity. Furthermore, high definition-digital versatile disks (HD-DVDs) and blu-ray disks, which have high recording capacities of 15 giga bytes (GB) or greater, have recently been developed.

Optical information storage media are being developed to achieve higher recording capacities. In order to increase recording capacity, a light source used to record information to the optical disk should have a short wavelength, and an objective lens to focus the light from the light source should have a high numerical aperture (NA). Alternatively, an information recording layer should include a plurality of recording layers, e.g., first through third layers L0 through Ln, as shown in FIG. 1. Here, Ls denotes spacer layers present between the recording layers.

However, as the wavelength of the light source decreases and the NA of the objective lens increases, a larger spherical aberration of a light spot generated by the light is induced according to variations in the thickness of a transparent cover layer, thereby degrading a recording/reproduction signal. Spherical aberration can be expressed as a multiple-order equation. In particular, when the NA of the objective lens is greater than 0.8, high-order spherical aberration that cannot be neglected is generated and even the following 4^{th} order spherical aberration should be considered:

$${W}_{40} = \frac{{n}^{2} - 1}{8 {n}^{3}} {NA}^{4} Δ d \qquad ( 1 )$$

where n denotes the refractive index of the transparent cover layer, NA denotes the NA of the objective lens, and Δd denotes the thickness variation of the cover layer. According to Equation 1, in the case of a recording/reproducing apparatus of the multi-layer optical disk using the objective lens with an NA greater than 0.8, large high-order spherical aberration occurs. To record or reproduce information to or from the first recording layer, a laser beam is focused on the first recording layer and aberration is corrected. Then, information is recorded or reproduced on the first recording layer. The shift of the focus of the laser beam from the first recording layer to a next recording layer is referred to as a focus jump.

In general, once the disk is loaded on a turn table, the recording/reproducing apparatus determines the type of disk loaded on the turn table and performs a focus pull-in operation for a recording layer of the disk loaded on the turn table. The apparatus then acquires control information such as focus servo, tracking servo, addresses, and the like. After the focus pull-in operation, which forms a focal point of a beam on a target recording layer of the disk, focusing adjusts the focus. Next, spherical aberration is corrected to optimize an address signal or a reproduction signal. Then, information is recorded or reproduced.

In particular, for a disk having a plurality of recording layers, there are some cases where, while information is reproduced/recorded on a current recording layer, a beam spot needs to be moved from the current recording layer to another recording layer. FIGS. 2A and 2B are timing diagrams to explain a process of performing a focus jump by supplying a kick-brake in a focus drive (FOD) signal when a detected focus error (FE) signal of a recording layer is greater than a standard level. The moment that a focus servo is opened, a layer shift control signal is applied and then an FE signal, a radio frequency (RF) sum signal, a radio frequency data communication (RFDC) signal, an RF signal, and an RF Envelope signal are monitored. When certain conditions are satisfied, a focus pull-in is performed, thereby rapidly and stably performing a focus jump.

In order to achieve a stable focus pull-in on the target recording layer during the focus jump, an FE signal of the target recording layer should be of a certain quality. U.S. Patent Application Publication No. 2002/0195540 discloses a focusing control apparatus and method for an optical pickup, wherein information is recorded or reproduced on a first recording layer, and a focus jump is performed from the first recording layer to a second recording layer after correcting spherical aberration for the second recording layer.

FIGS. 3A and 3B are timing diagrams illustrating FE signals on the first through third recording layers L0 through L2 of the disk after spherical aberrations on the respective recording layers have been corrected. As shown in FIGS. 3A and 3B, since spherical aberration on the first recording layer is corrected, a first FE signal FE0 of the first recording layer L0 has a better shape than a third FE signal FE2 of the third recording layer L2. When a focus jump is performed from the first recording layer, which is a current recording layer, to the third recording layer, which is a target recording layer, since the third FE signal FE2 of the third recording layer L2 is poor, distorted, or degraded, detecting a time when a focus pull-in is performed is difficult. As such, the risk of failing the focus jump is increased.

For the above reasons, as shown in FIGS. 3A and 3B, before the focus jump to the third recording layer L2 is performed, spherical aberration of the third recording layer L2 is corrected so that an FE signal of the certain quality for the third recording layer L2 may be achieved. Thereafter, a focus servo is opened and the focus jump is carried out.

However, as spherical aberration of the third recording layer L2 is corrected, the spherical aberration of the first recording layer L0 increases, thereby resulting in a poor FE signal with respect to the first recording layer L0. That is, a good FE signal with respect to the first recording layer L0 is generated, and after spherical aberration of the third recording layer L2 is corrected, a poor FE signal with respect to the first recording layer L0 is generated and a good FE signal with respect to the third recording layer L2 is generated. That is, while the spherical aberration of the third recording layer L2 is corrected, a poor FE signal with respect to the first recording layer L0 is generated. At this time, if focusing servo control is maintained, focus servo becomes unstable. If a correction time is lengthened, an actuator may be forced to move downward to a neutral position or further below the neutral position. Such problems may become serious when a thickness difference between intermediate layers of the multi-layer disk is high or the velocity of a spherical aberration correcting unit, such as a lens driving motor, is low.

If a focus jump is performed at this time, the focus jump cannot be performed in a kick and brake manner. Thus, a time consuming focus pull-in operation should be performed again on the recording layer. That is, while the aberration of the third recording layer L2 is corrected during the focus jump, the FE signal of the first recording layer L0 becomes poor, servo control is unstable, and much time is consumed to correct the aberration due to the large thickness of the spacer layers Ls, thereby causing the optical pickup and the actuator to drop. In this case, discontinuities may occur while recording or reproducing information, and, particularly in the case of the disk having a high deflection, the FE signal may be distorted during the spherical aberration correction of the target recording layer with the result being that the disk and the objective lens may collide with each other during vertical movement of the actuator.

### SUMMARY OF THE INVENTION

Aspects of the present invention provide an apparatus and method of rapidly and accurately controlling a focus jump between recording layers in a high-density multi-layer disk.

According to an aspect of the present invention, there is provided an apparatus for controlling a focus jump between recording layers in a high-density multi-layer disk, the apparatus comprising: an optical pickup comprising an objective lens focusing light on the disk, an aberration correcting unit, and a photodetector detecting light reflected from the disk; a signal processing unit generating a focus error signal from a signal output by the photodetector; a focus hold unit holding a focus servo of the optical pickup; a focus servo control unit controlling the focus servo of the optical pickup using the focus error signal; and a driving unit driving the optical pickup using a signal output from the focus servo control unit.

According to another aspect of the present invention, the focus hold unit may comprise: a focus error signal hold unit holding the focus error signal output from the signal processing unit; and a first switch switching between the signal processing unit and the focus servo control unit, or between the focus error signal hold unit and the focus servo control unit.

According to another aspect of the present invention, the focus error signal hold unit may hold the focus servo with any one selected from the group comprising a predetermined band-pass filtered focus error signal, a low-pass filtered focus error signal, and/or an average focus error signal.

According to another aspect of the present invention, the focus hold unit may hold the focus servo to perform the focus jump when the optical pickup is located at a lowest point during one rotation of the disk.

According to another aspect of the present invention, the focus hold unit may comprise: a focus drive signal hold unit holding a focus drive signal output from the focus servo control unit; and a second switch switching between the focus servo control unit and the driving unit, or between the focus servo control unit and the focus drive signal hold unit.

According to another aspect of the present invention, the focus drive signal hold unit may hold the focus servo with any one selected from the group comprising a predetermined band-pass filtered focus drive signal, a low-pass filtered focus drive signal, and/or an average focus drive signal.

According to another aspect of the present invention, there is provided a method of controlling a focus jump between recording layers in a high-density multi-layer disk using an optical pickup, the method comprising; giving a command to perform a focus jump from a current recording layer to a target recording layer; holding a focus servo for the current recording layer; correcting spherical aberration for the target recording layer; and performing the focus jump to the target recording layer.

According to another aspect of the present invention, the holding of the focus servo may comprise: detecting a first frequency generator signal of a spindle motor that rotates the disk; detecting a lowest point of the optical pickup during one rotation of the disk, and measuring a time interval from the start of the one rotation of the disk to the detection of the lowest point; and holding the focus servo to perform the focus jump when the measured time interval passes after a second frequency generator signal of the spindle motor is detected.

According to another aspect of the present invention, the holding of the focus servo may further comprise converting a velocity control mode into a constant angular velocity mode before the detecting of the first frequency generator signal.

According to another aspect of the present invention, the method may further comprise detecting a third frequency generator signal after the holding of the focus servo when the time interval passes after the third frequency generator signal is detected.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a multi-layer disk of the related art;

FIGS. 2A and 2B are timing diagrams for explaining a process of performing a focus jump by applying a kick-brake signal according to the related art;

FIGS. 3A and 3B are timing diagrams illustrating focus error signals on first through third recording layers of a disk after spherical aberrations of the respective recording layers are corrected according to the related art;

FIG. 4 is a block diagram of an apparatus for controlling a focus jump between recording layers in a high-density multi-layer disk according to an embodiment of the present invention;

FIG. 5 is a block diagram of an apparatus for controlling a focus jump between recording layers in a high-density multi-layer disk according to another embodiment of the present invention;

FIG. 6 is a graph illustrating variations in the position of an optical pickup during disk rotation;

FIG. 7 is a flowchart illustrating a method of controlling a focus jump between recording layers in a high-density multi-layer disk according to an embodiment of the present invention;

FIG. 8 is a detailed flowchart illustrating a method of controlling a focus jump between recording layers in a high-density multi-layer disk by holding a focus drive signal according to an embodiment of the present invention; and

FIG. 9 is a flowchart illustrating further operations which can be added to the method of FIG. 8 of controlling the focus jump in the high-density multi-layer disk.

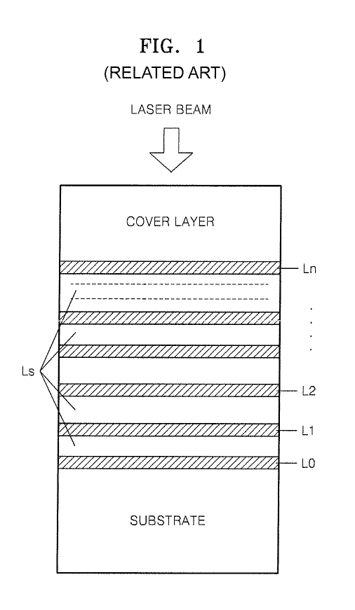

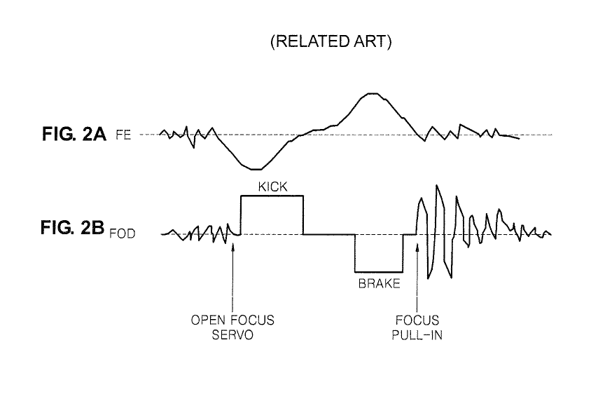

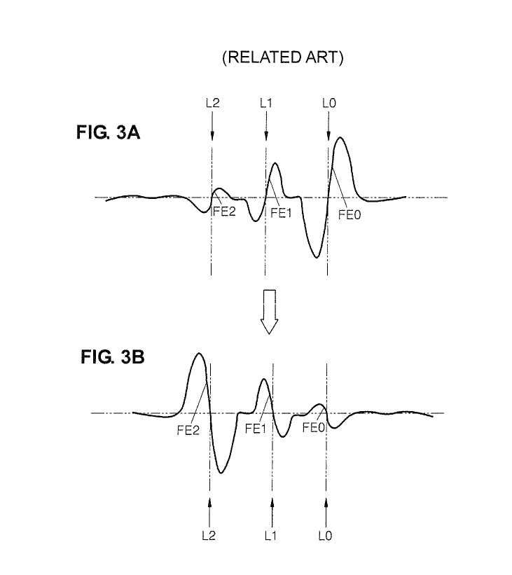

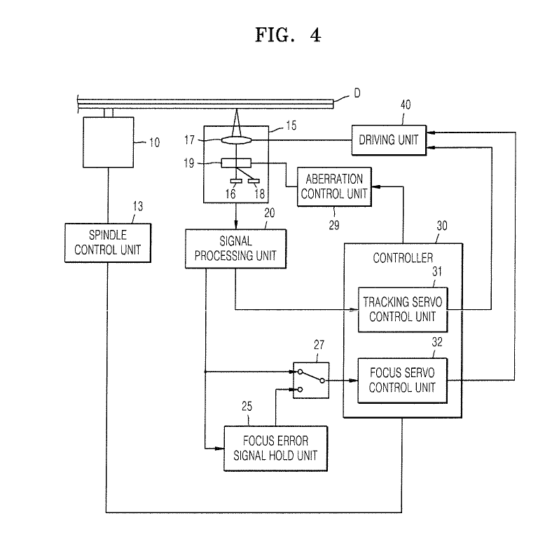

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An apparatus to control a focus jump according to aspects of the present invention includes a focus hold unit that locks a focus servo for a current recording layer before a focus jump is performed to rapidly and accurately perform the focus jump from the current recording layer to another recording layer in a high density multi-layer disk using an objective lens with a high numerical aperture (NA).

FIG. 4 is a block diagram of an apparatus to control a focus jump between recording layers according to an embodiment of the present invention. The apparatus includes an optical pickup 15 including an objective lens 17 that focuses light onto a disk D, and a driving unit 40 that controls focusing and tracking of the optical pickup 15. The disk D is rotated by a spindle motor 10 that is controlled by a spindle control unit 13.

The optical pickup 15 is an optical system that focuses light emitted from a light source 16 onto the disk D via the objective lens 17, and which detects light reflected by the disk D. The optical pickup 15 includes a photodetector 18 to receive the light reflected by the disk D and to convert the received light into an electrical signal, and an aberration correcting unit 19 to correct spherical aberration. The aberration correcting unit 19 may be any one selected from the group comprising an expander lens, a collimating lens, and/or a liquid crystal lens. The aberration correcting unit 19 is well known. Thus, a detailed explanation thereof will not be given.

A signal processing unit 20 generates a focus error (FE) signal and a tracking error signal from a signal output from the photodetector 18 and transmits the signals to a controller 30. The controller 30 includes a tracking servo control unit 31 to control the tracking of the optical pickup 15 using the tracking error signal, and a focus servo control unit 32 to control the focusing of the optical pickup 15 based on the FE signal. When the controller 30 gives a command to perform a focus jump from a current recording layer to a target recording layer, a focus hold unit locks a focus servo for the current recording layer before the focus jump is performed. The focus hold unit locks the focus servo using various methods, and may have various constructions according to the method employed.

Referring to FIG. 4, the focus hold unit may include an FE signal hold unit 25 that holds an FE signal output from the signal processing unit 20 and inputs the FE signal to the focus servo control unit 32. A first switch 27 switches between the signal processing unit 20 and the focus servo control unit 32, and between the FE signal hold unit 25 and the focus servo control unit 32. When the controller 30 issues a command to perform a focus jump, the first switch 27 turns on the FE signal hold unit 25, such that an FE signal held by the FE signal hold unit 25 is input to the focus servo control unit 32.

The FE signal hold unit 32 locks a focus servo with any one selected from the group comprising a predetermined band-pass filtered FE signal, a low-pass filtered FE signal, and/or an average FE signal. The FE signal held by the FE signal hold unit 25 is input to the focus servo control unit 32, and the focus servo control unit 32 generates a focus drive (FOD) signal based on the held FE signal and outputs the FOD signal to the driving unit 40. While the focus servo is controlled according to the held FE signal, an aberration control unit 29 stably adjusts the aberration correcting unit 19 to correct spherical aberration for the target recording layer. Consequently, since the optical pickup 15 is driven with a constant FE signal irrespective of the FE signal actually generated during the spherical aberration correction for the target recording layer, the optical pickup 15 is prevented from dropping due to a degradation of the FE signal of the current recording layer. As such, the performance of the focus jump from the current recording layer to the target recording layer is stable and rapid.

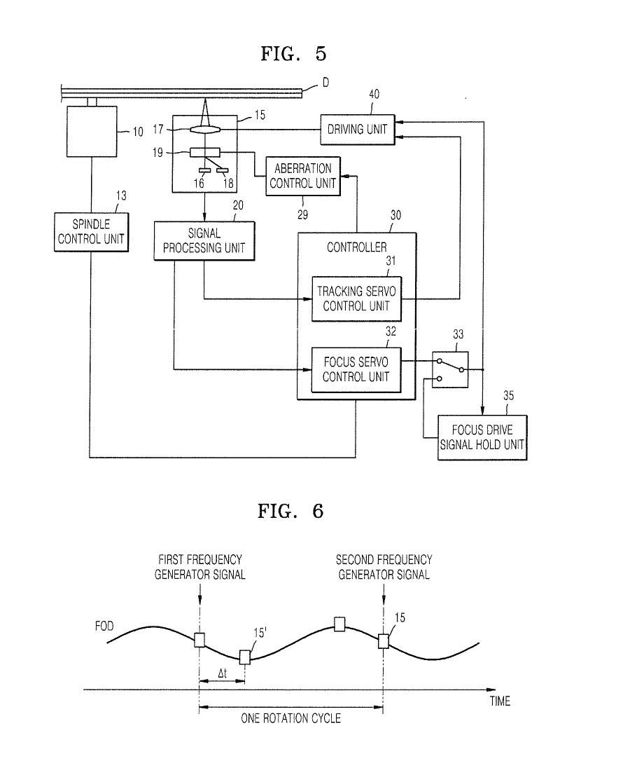

FIG. 5 is a block diagram of an apparatus to control a focus jump between recording layers according to another embodiment of the present invention. As shown in FIG. 5, a focus hold unit holds an FOD signal, and elements having the same reference numerals as those of FIG. 4 perform substantially the same functions and operations, and, as such, a detailed explanation thereof will not be given. The focus hold unit in FIG. 5 may include an FOD signal hold unit 35 that holds an FOD signal output from the focus servo control unit 32 and transmits the same to the driving unit 40. A second switch 33 switches between the focus servo control unit 32 and the driving unit 40, or between the focus servo control unit 32 and the FOD signal hold unit 35. When the controller 30 issues a command to perform a focus jump, the second switch 33 turns on the FOD signal hold unit 35, such that an FOD signal held by the FOD signal hold unit 35 is input to the driving unit 40.

The FOD signal hold unit 35 is able to hold the focus servo with any one selected from the group comprising a predetermined band-pass filtered FOD signal, a low-pass filtered FOD signal, and/or an average FOD signal. Since the focus servo of the optical pickup 15 is controlled according to the held FOD signal irrespective of an actual FE signal, even though the FE signal is distorted and degraded during spherical aberration correction for the target recording layer, the focus servo is able to be stably controlled according to the constant FOD signal without being affected by the FE signal.

A process of holding an FOD signal will now be explained.

The spindle control unit 13 generates a frequency generator (FG) signal that indicates the start of one rotation of the disk D being rotated by the spindle motor 10, and detects information on the position of the optical pickup 15 that is focusing light during the one rotation of the disk D. The optical pickup 15 is held to any one of the detected positions and then information on the held position is input to the FOD signal hold unit 35. As a result, the position of the optical pickup 15 is fixed without varying according to the focus servo control.

FIG. 6 is a graph of an FOD signal with reference to time, illustrating variations in the position of the optical pickup 15 according to the FOD signal during the rotation of the disk D. The focus servo may be locked by a holding of the optical pickup 15 to one of various positions, such as a lowest point 15′ thereof, during the one rotation of the disk D. The lowest point 15′ of the optical pickup 15 is detected from a time when a first FG signal that indicates the start of the one rotation of the disk D being rotated by the spindle motor 10 is generated, and a time interval Δt from the start of the first FG signal to the time the detection of the lowest point 15′ of the optical pickup 15 is measured. The position of the optical pickup 15 is held to allow for a performance of a focus jump when a time interval Δt passes after a second FG signal is generated.

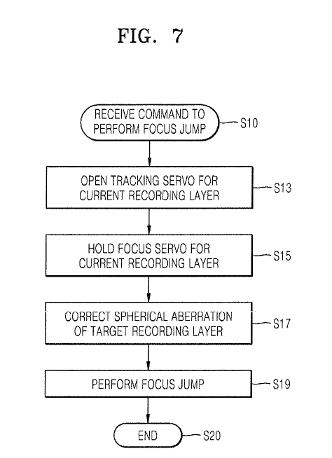

FIG. 7 is a flowchart illustrating a method of controlling a focus jump between recording layers according to an embodiment of the present invention. As shown in FIG. 7, in operation S10, a command to perform a focus jump between recording layers in a high-density multi-layer disk is received. In operation S15, a focus servo for a current recording layer is locked before the focus jump is performed from the current recording layer to a target recording layer. In operation S17, spherical aberration for the target recording layer is corrected. The current embodiment of FIG. 7 is characterized in that the focus servo for the current recording layer is held before the correcting of the spherical aberration for the target recording layer. In operation S19, the focus jump is performed.

Since the spherical aberration for the target recording layer is corrected after the focus servo for the current recording layer is held, even though an FE signal of the current recording layer is distorted, constant focus servo can be achieved without being affected by the FE signal. Consequently, the focus servo for the current recording layer can be prevented from being unstable due to degradation of the FE signal of the current recording layer during the spherical aberration correction for the target recording layer. Furthermore, in the case of a disk having a high deflection, since the focus servo for the current recording layer is held, the pickup is prevented from dropping and discontinuities are prevented during the recording/reproducing of information. As such, the focus jump is stably performed after the correction of the spherical aberration for the target recording layer. After the command to perform the focus jump between the recording layers is received, in operation S13, a tracking servo loop is opened since data recording or reproduction is stopped and there is no need to control the tracking servo loop.

According to an embodiment of the invention, instead of holding a signal input to the focus servo control unit 32 to hold the focus servo as shown in FIG. 4, a signal output from the focus servo control unit 32 may be held to hold the focus servo as shown in FIG. 5. Further, the method of holding the signal input to the focus servo control unit 32 may hold the focus servo with any one selected from the group comprising a predetermined band-pass filtered FE signal, a low-pass filtered FE signal, and an average FE signal. Still further, the method of holding the signal output from the focus servo control unit 32 may hold the focus servo with any one selected from the group comprising a predetermined band-pass filtered FOD signal, a low-pass filtered FOD signal, and/or an average FOD signal.

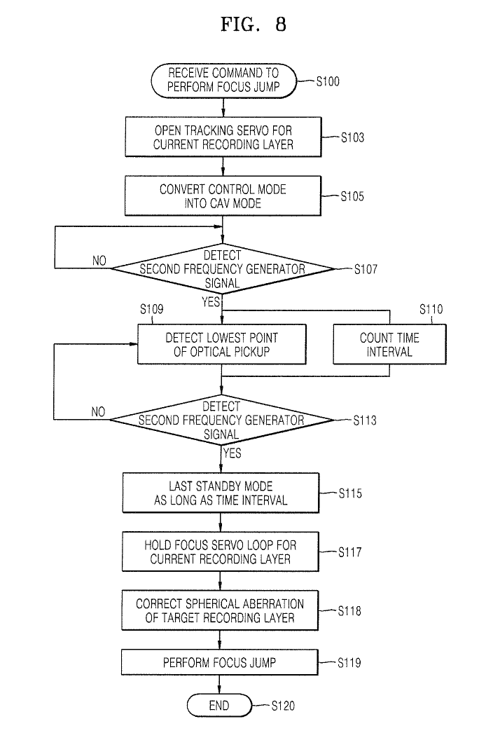

FIG. 8 is a detailed flowchart illustrating a method of controlling a focus jump by holding an FOD signal according to an embodiment of the present invention.

A method of holding an FOD signal by keeping the optical pickup 15 at a predetermined position will now be explained with reference to FIGS. 5 and 8. In operation S100, a command to perform a focus jump between recording layers is given from the controller 30. In operation S103, a tracking servo loop for a current recording layer is opened. In operation S105, a control mode for the current recording layer is converted into a constant angular velocity (CAV) mode to maintain the rotation rate of the disk D at a constant rate since data recording/reproduction on the current recording layer is stopped. The tracking servo loop for the current recording layer is opened, and the focus servo is continuously operated.

In operation S107, an FG signal, which is information on the velocity of the spindle motor 10 and which is provided from the spindle control unit 13, is detected. The disk D is rotated by the spindle motor 10, and the rotational velocity of the spindle motor 10 is controlled by the spindle control unit 13. The FG signal of the spindle motor 10 output from the spindle control unit 13 is transmitted to the controller 30. The FG signal is repeated every one rotation of the disk D. That is, the FG signal is provided by the spindle control unit 13 during every single rotation of the disk. In operation S109, one point of the optical pickup 15, such as the lowest point thereof, is detected from a time when a first FG signal is detected. In operation S110, a time interval Δt (see FIG. 6) from a time when the first FG signal is input to a time when the lowest point of the optical pickup 15 is detected is measured.

In operation S113, a second FG signal is detected. In operation S115, a standby mode lasts from the time of the detection of the second FG signal to as long as the time interval Δt. In operation S117, the focus servo is held to perform the focus jump when the lowest point of the optical pickup 15 is detected. After the focus servo is stably held, spherical aberration of a target recording layer is corrected. Hence, the focus servo is prevented from being unstable due to distortion of an FE signal of the current recording layer during the spherical aberration correction for the target recording layer, and the focus jump to the target recording layer is able to be stably and rapidly performed. In operation S119, the focus jump is performed. After the focus jump to the target recording layer is carried out, tracking on the target recording layer is performed, and spherical aberration, RF/servo gain, etc., are each adjusted to achieve an optimal data reproduction and recording performance. The focus jump may be performed at any arbitrary time after the focus servo is held in this manner. However, to more stably perform the focus jump, a time when the focus is performed can be limited as follows.

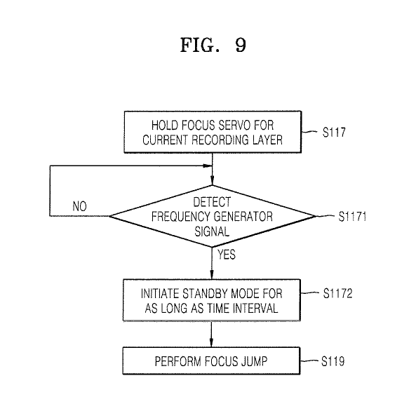

FIG. 9 is a flowchart illustrating further operations which can be added to the method of controlling the focus jump of FIG. 8 according to embodiments of the present invention. As shown in FIG. 9, in operation S117, the focus servo is held to perform the focus jump when the lowest point of the optical pickup 15 is detected. In operation S1171, a third FG signal is detected. In operation S1172, a standby mode lasts from the detection of the third FG signal for the time interval Δt. In operation S119, the focus jump is performed. After the third FG signal is detected, when the time interval Δt has passed, the optical pickup 15 is located at the lowest point and the acceleration of the optical pickup 15 at this time is substantially zero (0). Accordingly, the focus jump may be very stably performed when the optical pickup 15 is located at the lowest point.

While FIG. 4 shows that the signal input to the focus servo control unit 32 is held and FIG. 5 shows that the signal output from the focus servo control unit 32 is held, both the signals input to and output from the focus servo control unit 32 may be held.

As is described above, the apparatus to control the focus jump, according to aspects of the present invention, rapidly and accurately controls the focus jump between the recording layers in the high-density multi-layer disk on which data is recorded and reproduced using the objective lens having the high NA. When focusing is performed using an objective lens having a high NA, for example, an NA greater than 0.8, since an FE signal on each recording layer is very sensitive to spherical aberration, an FE signal of a current recording layer may be significantly distorted or degraded after spherical aberration of a target recording layer is corrected. According to aspects of the present invention, however, since the focus servo for the current recording layer is held before the spherical aberration correction of the target recording layer, the focus servo is rarely affected by the distortion of the FE signal of the current recording layer. Therefore, problems, such as pickup drop, which may be caused during the spherical aberration correction of the target recording layer, can be prevented and the focus servo for the current recording layer can be stably controlled during the spherical aberration correction.

Moreover, the method of controlling the focus jump in the high-density multi-layer disk, according to aspects of the present invention, prevents the focus servo from being unstable due to distortion of an FE signal by holding the focus servo for a current recording layer, and corrects spherical aberration of a target recording layer after the stable control of the focus servo. Therefore, since an FE signal of the target recording layer is good after the spherical aberration correction, the focus jump can be performed stably and rapidly. In addition, in the case of a disk having a high deflection, pickup drop can be prevented and the chances for success in the focus jump can be increased remarkably.

According to aspects of the invention, the methods described above may be embodied as computer readable media having programs stored thereon to execute the methods.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus to control a focus jump between recording layers in a high-density multi-layer disk, the apparatus comprising:
an optical pickup including an objective lens to focus light on the disk, an aberration correcting unit, and a photodetector to detect the light reflected from the disk;
a signal processing unit to generate a focus error signal from a signal output by the photodetector;
a focus hold unit to hold a focus servo of the optical pickup;
a focus servo control unit to control the focus servo of the optical pickup using the focus error signal during the holding of the focus servo of the optical pickup; and
a driving unit to drive the optical pickup using a signal output from the focus servo control unit.

2. The apparatus according to claim 1, wherein the focus hold unit comprises:
a focus error signal hold unit to hold the focus error signal output from the signal processing unit; and
a first switch to switch between the signal processing unit and the focus servo control unit, or between the focus error signal hold unit and the focus servo control unit.

3. The apparatus according to claim 2, wherein the focus error signal hold unit holds the focus servo with any one selected from the group comprising a predetermined band-pass filtered focus error signal, a low-pass filtered focus error signal, and/or an average focus error signal.

4. The apparatus according to claim 1, wherein the focus hold unit holds the focus servo to perform the focus jump when the optical pickup is located at a lowest point during one rotation of the disk.

5. The apparatus according to claim 1, wherein the focus hold unit comprises:
a focus drive signal hold unit to hold a focus drive signal output from the focus servo control unit; and
a second switch to switch between the focus servo control unit and the driving unit, or between the focus servo control unit and the focus drive signal hold unit.

6. The apparatus according to claim 5, wherein the focus drive signal hold unit holds the focus servo with any one selected from the group comprising a predetermined band-pass filtered focus drive signal, a low-pass filtered focus drive signal, and/or an average focus drive signal.

7. The apparatus according to claim 1, wherein the aberration correcting unit is any one of an expander lens, a collimating lens, and a liquid crystal lens.

8. A method of controlling a focus jump between recording layers in a high-density multi-layer disk using an optical pickup, the method comprising;
commanding a performance of a focus jump from a current recording layer to a target recording layer;
holding a focus servo for the current recording layer;
correcting spherical aberration for the target recording layer during the holding of the focus servo; and
performing the focus jump to the target recording layer.

9. The method according to claim 8, wherein the holding of the focus servo comprises:
detecting a first frequency generator signal of a spindle motor that rotates the disk;
detecting a lowest point of the optical pickup during one rotation of the disk, and measuring a time interval from the start of the one rotation of the disk to the detection of the lowest point; and
holding the focus servo to perform the focus jump when the measured time interval passes after a second frequency generator signal of the spindle motor is detected.

10. The method according to claim 9, wherein the holding of the focus servo further comprises converting a velocity control mode into a constant angular velocity mode before the detecting of the first frequency generator signal.

11. The method according to claim 9, further comprising detecting a third frequency generator signal after the holding of the focus servo when the time interval passes after the third frequency generator signal is detected.

12. The method according to claim 8, wherein the holding of the focus servo comprises holding a focus error signal input to the focus servo control unit.

13. The method according to claim 12, wherein the focus error signal is any one selected from the group comprising a predetermined level of focus error signal, a low-pass filtered focus error signal, and/or an average focus error signal.

14. The method according to claim 8, wherein the holding of the focus servo comprises holding a focus drive signal output from the focus servo control unit, the focus drive signal being any one selected from the group comprising a predetermined level of focus drive signal, a low-pass filtered focus drive signal, and/or an average focus drive signal.

15. The method according to claim 8, wherein the holding of the focus servo comprises holding the focus servo to perform the focus jump when the optical pickup is located at a lowest point.

16. An apparatus to control a focus jump between a current layer and a target layer of an optical disk, the apparatus comprising:
an optical pickup to focus light on the disk including an aberration correcting unit to correct a spherical aberration of the layers of the disk, and a photodetector to detect the light reflected from the disk;
a signal processing unit to generate a focus error signal from a signal output by the photodetector based on the detected light;
a hold unit to hold the optical pickup for a predetermined time before the focus jump during which the spherical aberration of the target layer is corrected so as to maintain the focus of the light on the current layer; and
a driving unit to drive the focus jump to the target layer once the predetermined time is complete.

17. The apparatus according to claim 16, wherein the predetermined time is a time from a beginning of a rotation of the disk to a time when a position of the disk is at a lowest point.

18. A method of controlling an optical pickup following a command to perform a focus jump between a current recording layer and a target recording layer of an optical disk, the method comprising;
holding a focus servo for the current recording layer for a predetermined time;
correcting spherical aberration for the target recording layer while a focusing of light emitted from the optical pickup on the current recording layer is maintained during the holding;
determining that the predetermined time is complete; and
performing the focus jump to the target recording layer.
